(19) United States
(12) Patent Application Publication
(10) Pub. No.: US 2014/0143272 A1
(43) Pub. Date: May 22, 2014

(54) METHOD FOR INQUIRING NEUROTRANSMITTER-RELATED INFORMATION IN AN IMAGE DATABASE SYSTEM

(71) Applicant: NATIONAL TSING HUA UNIVERSITY, Hsinchu (TW)

(72) Inventor: Ann-Shyn Chiang, Hsinchu (TW)

(73) Assignee: NATIONAL TSING HUA UNIVERSITY, Hsinchu (TW)

(21) Appl. No.: 14/165,479

(22) Filed: Jan. 27, 2014

Related U.S. Application Data
(63) Continuation-in-part of application No. 12/977,505, filed on Dec. 23, 2010.

(51) Int. Cl. G06F 17/30

(52) U.S. Cl. CPC G06F 17/30244; G06F 17/30424
USPC 707/769; 707/705

(57) ABSTRACT

The present invention relates to a method for inquiring neurotransmitter-related information in a neuronal image database, comprising the steps of: (a) selecting a neurotransmitter, secreted by neurons within a brain, to inquire the neurotransmitter-related information in the neuronal image database system; and (b) displaying spatial distribution of neurons associated with the neurotransmitter within the brain on a display screen.

### CROSS-REFERENCES TO RELATED APPLICATIONS

This application is a Continuation-in-part of the pending U.S. patent application Ser. No. 12/977,505, filed on Dec. 23, 2010, incorporated herein by reference in its entirety.

### FIELD OF THE INVENTION

This invention relates to a method of using a neuronal image database system for providing neurotransmitter related information.

### DESCRIPTION OF PRIOR ART

Neurotransmitters are molecules that are released by a presynaptic neuron into the synaptic cleft and cause a change in the postsynaptic membrane potential. Neurotransmitters transmit the information from neuron to neuron within the brain and further transmit to the whole body. Neural network is the foundation of coordinating functions in animals, which is responsible for normal operations and behaviors. Abnormalities in the production or functioning of certain neurotransmitters had been reported and been related to diseases including Parkinson's disease, amyotrophic lateral sclerosis, and clinical depression. The distribution of neurons with specific neurotransmitter reflects the functional arrangements in the nervous system, may also reflect the possible modulation sites, by environment, drugs or other chemicals. Therefore, by obtaining the information of distribution and localization of the neurotransmitters, the researchers can have further understanding of the possible function of specific neurotransmitter and interaction among neurons. The biosynthesis of some of neurotransmitters is summarized as the following.

The biosynthesis of dopamine is originated from L-tyrosine; it is converted to L-Dopa by the enzyme tyrosine hydroxylase (TH). The L-Dopa is then converted to dopamine with the help of DOPA decaboxylase and aromatic L-amino acid decarboxylase. The biosythesis of octopamine is originated from tyrosine; it is converted to tyramine by the enzyme tyrosine decarboxylase (Tdc). The Tyramine is then converted to octopamine with the help of the enzymen tyramine β-hydroxylase. In particular, the enzyme Tdc has a subtype, Tdc2, that is presented only in the Drosophila brain (Cole, S. H. et al., 2005 Two functional, but noncomplementing, Drosophila tyrosine decarboxylase genes: distinct roles for neural tyramine and octopamine in female fertility. J. Biol. Chem. 280, 14948-14955). The biosynthesis of acetylcholine is originated from choline and acetyl-CoA with the help of the enzyme choline acetyltransferase (Cha). The biosynthesis of gamma-aminobutyric acid (GABA) is originated from glutamate with the help of the enzyme L-glutamic acid decarboxylase (Gad). The biosynthesis of serotonin is originated from L-tryptophan; it is converted to the 5-hydroxy-L-tryptophan (5-HTP) by the enzymes L-tryptophan-5-monooxygenase and typtophan hydroxylase (TpH). The 5-HTP is than converted to serotonin with the help of enzymes 5-hydroxytryptophan decarboxylase and Aromatic L-amino acid decarboxylase. The glutamate is stored in the synaptic vesicles with the help of a protein called the vesicular glutamate transporter (VGlut). Therefore, the presence of the transporter reflects the usage of glutamate as the neurotransmitter.

The fruit fly (Drosophila melanogaster) has been used as an experimental organism in studies of genetics for decades. It is now widely used in molecular genetics, biochemical techniques, cell biological techniques and physiological techniques. Therefore, the fruit fly has played a central role in the development of biology during the 20th century and led in providing new physiological information in cellular function and behavioral adjustments. In order to achieve a more comprehensive understanding about an animal as a system, a multidisciplinary approach is required, such as those of developmental biology and neurobiology.

Central nervous system (CNS) drug discovery is rapidly evolving nowadays. Older methods are giving way to newer technologies that include bioinformatics, structural biology, genetics, and modern computational approaches. It's important to understanding the complex interactions between the components within a biological system that lead to modifications in output, such as changes in behavior or development. It may be a way of identifying new therapies. One approach is the use of model genetic organisms such as the fruit fly. The similarity between mode of drug action, behavior, and gene response in D. melanogaster and mammalian systems and the feasibility in experimental operations have recently made the fly an attractive system to study fundamental neuropharmacological processes relevant to human diseases (Armstrong, J D and Van Hemert J I, 2009 Towards a virtual fly brain Phil. Trans. R. Soc. A 367, 2387-2397). Therefore, the use of the fly offers a speedy, economic approach that may result in an accelerated discovery.

The 2D and 3D image of brain is now well available due to the progress of technologies. Imaging is a vital procedure in the research area of medicine and developmental biology. The image is acquired from dissected tissue through stereomicroscopy or confocal microscopy. By using associated software, the system may be used to generate 2D optical sections and 3D models. Combining and utilizing the image information make the progress of the discovery of biology faster. However, most of the images of neurons in brains are 2D and not associated with one another anatomically. It is unpractical to extract the 3D information out of 2D images. A systematic collection of neuronal image with their relative positions and the neurotransmitter matching the real physiological system in 3D has not been available until now. In order to understand the role of a single neuron and its neurotransmitter, it is necessary to know the possible interactions of the neuron with other members along its pathway. Therefore, the 3D image of neuron may help researchers to have better understanding of the brain anatomy, neuron interaction and further related function.

### BRIEF DESCRIPTION OF THE DRAWINGS

FIG. 1 illustrates a diagram of the database entrance. The user may enter the database and views the diagram before giving any instruction.

FIG. 2 illustrates a query diagram of the database where the user makes query and instruction.

FIG. 3 illustrates a diagram of result when a user activates the “Browsing”. The image of neuron is displayed after pointing to “jpg”.

FIG. 4 illustrates a diagram of result for a user after keying the key word or making query in FIG. 2. The information related to neurotransmitter, comprising gene encoding the key enzyme for the synthesis of the neurotransmitter, spatial distribution and morphological similarity are shown in the diagram.

### SUMMARY OF THE INVENTION

The present invention provides a method for inquiring neurotransmitter-related information in a neuronal image database, comprising the steps of:

(a) selecting a neurotransmitter, secreted by neurons within a brain, to inquire the neurotransmitter-related information in the neuronal image database system; and

(b) displaying spatial distribution of neurons associated with the neurotransmitter within the brain on a display screen.

### DETAILED DESCRIPTION OF THE INVENTION

The present invention provides a method for inquiring neurotransmitter-related information in a neuronal image database system, comprising the steps of selecting or keying a neurotransmitter, secreted by neurons within a brain, to inquire the neurotransmitter-related information in the neuronal image database system; and displaying spatial distribution of the neurons associated with the neurotransmitter within the brain on a display screen. The neuronal image database system for providing neurotransmitter-related information comprises a database of three-dimensional morphological information of neuron and the associated neurotransmitters and a user interface for end users to access the information with the peripheral computer devices, such as key board or mouse. The three-dimensional morphological information is built up within a standard model brain which is divided into fifty-eight symmetrically distributed areas. The user specifies selections on the interface with keywords. The keyword may be neurotransmitters, a location or area of the brain, or an image file name. The neurotransmitter is selected by entering the name of the neurotransmitter as the keyword. After keying the keyword, the information relates to the specific neuron or neurotransmitter are shown in the diagram. The neurotransmitters comprise dopamine, glutamate, serotonin, acetylcholine, octopamine and gamma-amino butyric acid. In a preferred embodiment, the information in the database is from the Drosophila.

Images of single neurons were generated by engineering the green fluorescent protein (GFP), under the control of a specific gene, into embryos of the fruit flies. Through specific gene promoter, the expression of the GFP protein is controlled by specific condition. By observation of expression of the GFP protein, the development information of the gene is illustrated. The specific gene begins to express at certain specific developing stage is observed. The image of the protein expression is acquired by microscope. The category of these neurons is determined by the production of the kind of neurotransmitter that the gene is involved in. Further categorization is according to the birth time of these neurons during the development. Each neuronal image is standardized for its size and position. The relative position within a standard model brain of these neurons is determined with computer aided calculations. Eventually, individual neurons from the brain of an adult fruit fly are collected with a string of systematic information, gene and the type of neurotransmitter involved, birth time and 3D spatial coordinate within a standard brain space. The image database thus constructed provides a digital atlas for the brain networks of fruit flies.

By keying in or selecting the specific neurotransmitter, the user can access the information of the neurons which secrete the neurotransmitter in fruit flies. The information includes the genes which encode protein components along the biochemical pathway of the neurotransmitter within cells, spatial distribution, space coding, space similarity and annotation of the neuron which secretes the transmitters. The image for a neuron in the brain comprises original and standard volumetric and simplified skeleton images. The volumetric images construction is illustrated in example 1. The simplified skeleton image is constructed according to our previous patent, U.S. Pat. No. 8,126,247. The spatial distribution of the neurotransmitter or the neuron secretes the neurotransmitter is illustrated in table or three-dimensional image of neurons as in U.S. Pat. No. 8,520,933. The brain of Drosophila is divided into fifty-eight areas. Theses areas are symmetrically distributed. The table illustrates the distribution of the neurotransmitter or the neuron secretes the neurotransmitter in each divided-brain area of Drosophila. The space coding is performed according to the spatial distribution and is illustrated as code which represents of the spatial localization for each neuron. The space similarity shows other neuron images which have similarity morphology with the present neuron. The gender, age, birth timing and lineage of the present Drosophila image are also shown.

The neurotransmitter-related information in the neuronal image database system may be inquired by selecting the neurotransmitter, gender, driver gene, birth timing, lineage, annotation, cell body domain, innervation sites, result order, browsing, more detail, or a combination thereof. The neuronal image database system further comprises an interface for user access to the neuronal image database system. The query interface comprises buttons for the user to access categorized information containing single neuronal images associated with neurotransmitters by clicking the buttons and a plurality of query boxes to access the embedded information in the neural image database system.

The query boxes in the interface are categorized into neurotransmitter, gender, driver gene, birth timing, lineage, annotation, cell body domain and innervation sites. The user chooses the specific categories by clicking the box and selects a specific demand, for example, chose the specific neurotransmitter in the neurotransmitters category and chose the specific development stage in the birth timing category. After giving the instruction, the user receives images satisfying the criteria. The buttons and query boxes in the interface are shown on a display screen connected to the present neural image database system to provide information from a plurality of graphs and presentation scheme. The interface may further comprise a result order for user to select.

The interface is written in scripting language. In a preferred embodiment, the interface is written in Hypertext Preprocessor (PHP).

Through the three-dimensional images, the user can easily obtain the neurotransmitter spatial distribution in the Drosophila brain and help the user to have further understanding of the interactions among neurons with different neurotransmitters in it. This may enhance the progress of the research in brain functions and the remedy of its malfunction.

### EXAMPLE

The examples below are non-limiting and are merely representative of various aspects and features of the present invention.

### Example 1

### Collecting the 3D Images of Neurons

The presence of the gene encoding TH was used to reflect the appearance of dopamine in the neuron. The presence of the gene encoding Tdc2 was used to reflect the appearance of octopamine in the neuron. The presence of the gene encoding TpH was used to reflect the appearance of serotonin in the neuron. The presence of the gene encoding Cha was used to reflect the appearance of acetylcholine in the neuron. The presence the gene encoding Gad was used to reflect the appearance of GABA in the neuron. The presence of the gene encoding VGlut was used to reflect the appearance of glutamate in the neuron.

The green fluorescent protein (GFP) was introduced into the embryos of fruit flies. The images of the neurons were captured by microscope when the GFP was expressed and illuminated. The following transgenic fly lines were used for the six different neurotransmitter related neuronal image generation: (i) hs-FLP/+; FRT^{g13}, tubP-GAL80/FRT^{g13}, UAS-mCD8::GFP; TH-GAL4(DGRC)/+, for dopamine related neurons; (ii) hs-FLP,FRT^{19A}, tubP-GAL80/FRT^{19A}, UAS-mCD8::GFP; Gad1-GAL4/+; +, for the GABA related ones; (iii) hs-FLP/VGlut-GAL4; FRT^{g13}, tubP-GAL80/FRT^{g13}, UAS-mCD8::GFP; +, for the glutamate related neurons; (iv) hs-FLP,FRT^{19A}, tubP-GAL80/FRT^{19A}, UAS-mCD8::GFP; Tdc2-GAL4/+; +, for the octopamine related ones; (v) hs-FLP/+; FRT^{g13}, tubP-GAL80/FRT^{g13}, UAS-mCD8::GFP; TpH-GAL4/+, for the serotonin related neurons and (vi) hs-FLP,FRT^{19A}, tubP-GAL80/FRT^{19A}, UAS-mCD8::GFP; Cha-GAL4, UAS-mCD8:: GFP/+; +, for the acetylcholine related ones.

To ensure covering the most neurons giving birth at different time windows in MARCM labeling, we used a tiling protocol of heatshock treatment in a 37° C. water bath for 3 to 60 minutes with 50% overlapping periods, depending on the Gal4 driver used, throughout the entire development from embryo to adult eclosion. The procedure of brain tissue preparation, e.g. fixation, for microscopy is known to people familiar with the art therefore is omitted here. Finally, brain samples were directly cleared in the tissue clearing reagent for observation.

Sample brains were always imaged from anterior to posterior under a confocal microscope, e.g. Zeiss LSM 510, with a 40× water-immersion objective lens (N.A. value 1.2, working distance 220 μm). To overcome the limited field of view under high magnification, each brain was scanned in 2 parallel stacks of confocal images with some overlaps between the 2 brain hemispheres. The 2 image were stacked into a single dataset with a 3D image stitching algorism, with the overlapped region as a reference. The distance between successive images, Z-axis distance, was adjusted for the refractive index mismatch between the air and mounting medium as described previously (Liu, Y. C. & Chiang, A. S., High-resolution confocal imaging and three-dimensional rendering. Methods 30 (1), 86-93). One example of the better settings for proper image acquisitions were as follow: scanning speed 7, resolution 1024×1024, line average 4 times, zoom 0.7, optical slice thickness 1 μm.

To compile all of the collected single neuron images onto the common brain model, GFP-labeled neuronal images were first semi-automatically segmented with the aid of an image process program, e.g. Amira, as the original volumetric image. Individual neuronal images was aligned and registered into a standard Drosophila brain model (Wu, C. C. et al. Algorithm for the creation of the standard Drosophila brain model and its coordinate system. 5th International Conference on Visual Information Engineering VIE, Xi'an, China, pp. 478-483 (2008)) for its proper position with physiological relevance (a preprocess system is patent pending), as the standard volumetric image. The center point of the soma was determined and spatially registered for informatics analysis. A page of detailed neural information was generated to register the biological characters.

### Example 2

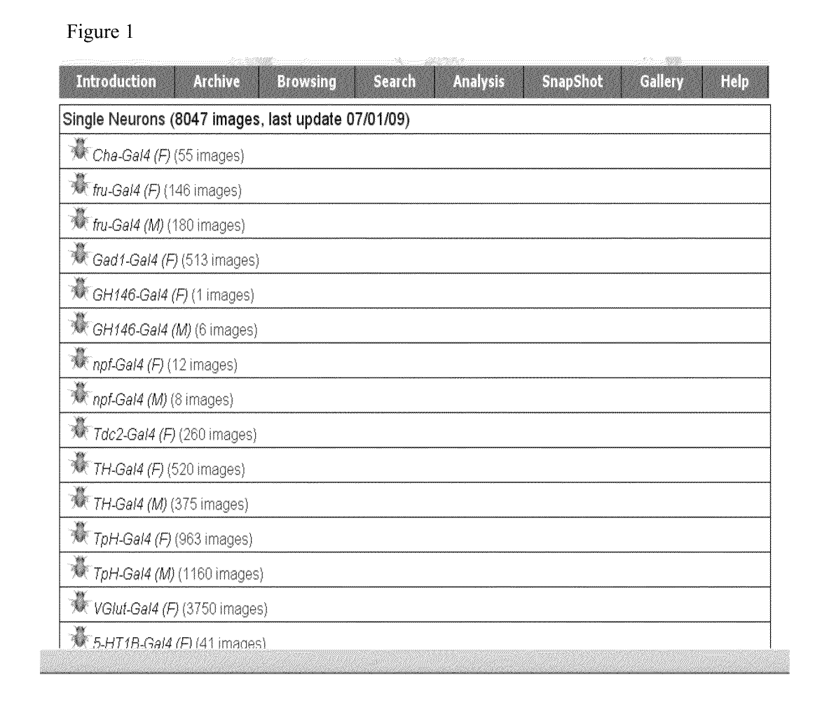

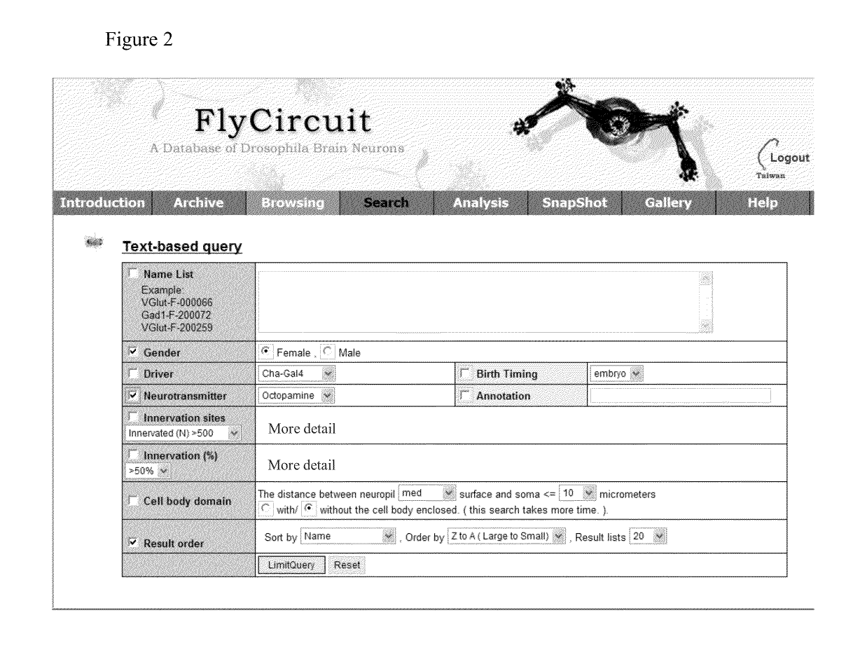

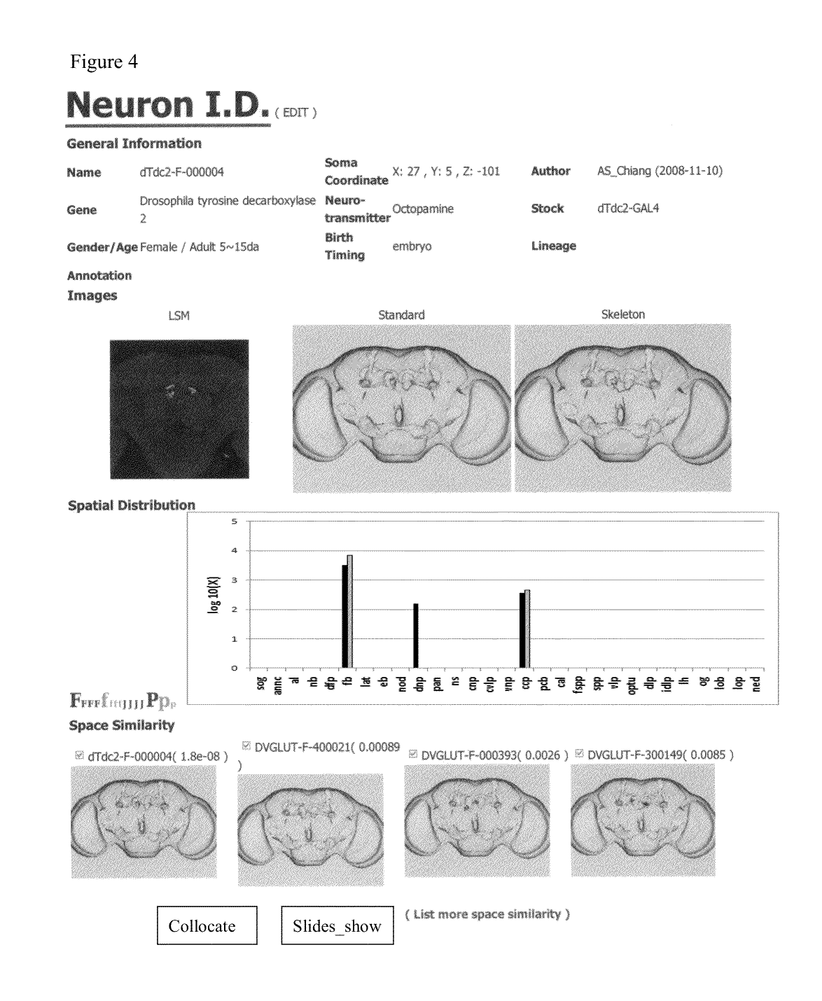

One embodiment of the present invention related to retrieve information from the neuron database system. The database system received the query from the user. The user selected keyword which was neurotransmitter, for example, octopamine. The database system stored a plurality of information, comprising: the gene encodes the neurotransmitter, spatial distribution, space coding, space similarity and annotation of the neuron which secreted the neurotransmitter. The demonstration images and the space similarity were shown as projections of three-dimensional images. The neuron database system of the present invention comprised an interface with buttons and a plurality of query boxes for the user to access the information. When a query was made by the user, the database is instructed to access the different information related to the specific neurotransmitter and output the result after processing. The query was made by the users when they enter the database and view the diagram shown as FIG. 1. The user could enter the query interface, FIG. 2, by click on the button of “search” in FIG. 1. The user entered the query interface could further choose a specific neurotransmitter or/and choose a specific gene, and then further detailed information was shown as FIG. 4. The information related to a neuron secreted octopamine was shown in a diagram. The gene encoded octopamine was shown at the top of the diagram. The demonstration images were shown as two-dimension jpg picture and three-dimensional image. The spatial distribution was shown as table and expressed by Log₁₀(X), where X is the voxel number in the specific brain region. The space similarity was shown as projections from three-dimensional images. The source of image information was also shown on the top of diagram, comprising the age, gender, birth timing and lineage. From the diagram of the database system, the user can easily access the related information and have a better understanding of the specific neurotransmitter and the neurons in Drosophila. In addition to the neurotransmitter, there were a plurality of query boxes for the user to narrow the searching scope by checking the box, as shown in FIG. 2, and to get the information in need. The query boxes which were for activating search function comprised neurotransmitter, gender, driver of gene, birth timing, annotation, cell body domain, innervation sites and result order. The user selected the specific query box and gave instruction further by choosing a specific item, for example, the specific gene, the specific neurotransmitter and the specific birth timing, to receive the specific information.

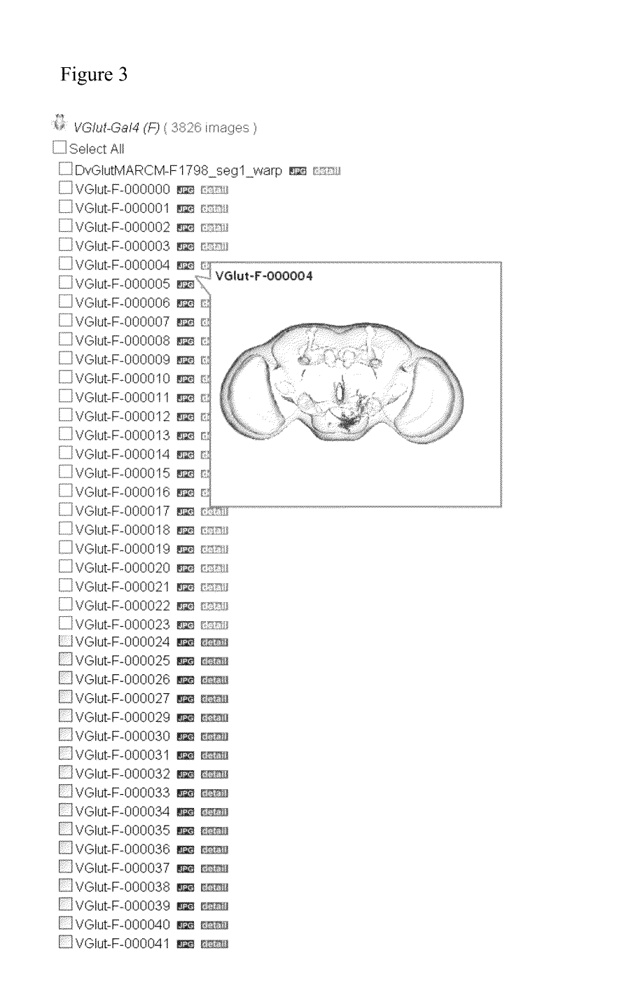

Another embodiment of the present invention related to retrieve information from the neuron database system. The user entered the database and viewed the diagram as FIG. 1, and then the user viewed all the different transmitters information when he gave the instruction by clicking the button of “browsing” in FIG. 1 and a part of the result was shown in FIG. 3. Furthermore, the user saw the images when the cursor was pointed to the ‘jpg’ and a comprehensive table was displayed when the ‘more detail’ button was clicked.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. The processes and methods for producing them are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

What is claimed is:

1. A method for inquiring neurotransmitter-related information in an image database system, comprising the steps of:
(a) selecting a neurotransmitter, secreted by neurons within a brain, to inquire the neurotransmitter-related information in the image database system; and
(b) displaying spatial distribution of the neurons associated with the neurotransmitter within the brain on a display screen.

2. The method of claim 1, wherein the neurotransmitter is selected from the group consisting of dopamine, glutamate, serotonin, acetylcholine, octopamine, and gamma-amino butyric acid.

3. The method of claim 1, wherein the neurotransmitter is selected by entering a name of the neurotransmitter as keywords.

4. The method of claim 1, wherein the neurotransmitter-related information is further inquired by selecting the neurotransmitter, gender, driver gene, birth timing, lineage, annotation, cell body domain, innervation sites, result order, browsing, more detail, or a combination thereof.

5. The method of claim 4, wherein the neurotransmitter, gender, driver gene, birth timing, lineage, annotation, cell body domain, innervation sites, result order, browsing, or more detail are selected by checking one or more buttons, one or more query boxes, or a combination thereof, wherein the buttons and query boxes are provided on the display screen.

6. The method of claim 5, wherein the buttons and query boxes are categorized to provide information of the neuronal image database system through a plurality of graphs and presentation scheme and are arranged on the display screen.

7. The method of claim 1, wherein the neurotransmitter-related information is inquired by selecting an image file name.

8. The method of claim 1, wherein the neurotransmitter-related information is inquired by selecting a location of the brain.

9. The method of claim 1, wherein the spatial distribution of the neurons within the brain are constructed within a standard model brain.

10. The method of claim 9, wherein the standard model brain is divided into fifty-eight symmetrically distributed areas.

11. The method of claim 1, wherein the spatial distribution of the neurons within the brain is displayed in volumetric and skeletal images.

12. The method of claim 1, wherein the spatial distribution of the neurons within the brain is expressed by Log₁₀(X), wherein X is a voxel number in a specific divided brain area.

13. The method of claim 1, wherein the inquired neurotransmitter-related information is further displayed in tables, two-dimensional pictures or three-dimensional images.

14. The method of claim 1, wherein the displayed neurotransmitter-related information further comprises genes which encode protein components along a biochemical pathway of the neurotransmitter within cells.

15. The method of claim 1, wherein the displayed neurotransmitter-related information further comprises space similarity of the neurons which is shown as projections of three-dimensional images.

16. The method of claim 1, wherein the displayed neurotransmitter-related information further comprises space coding and annotation of the neurons.

17. The method of claim 1, wherein the displayed neurotransmitter-related information is from Drosophila.
